(19) United States
(12) Patent Application Publication
(10) Pub. No.: US 2026/0196763 A1
(43) Pub. Date: Jul. 9, 2026

(54) MODULAR CHARGING APPARATUS, INSTALLING METHOD THEREOF, EXPANSION METHOD AND REDUCTION METHOD THEREOF, CURRENT DISTRIBUTION MANAGEMENT METHOD, CHARGING METHOD

(71) Applicant: YOUPOWER AG., Lamone (CH)

(72) Inventor: Emanuele Giovanni ROMANO, San Vittore (CH)

(21) Appl. No.: 18/871,277

(22) PCT Filed: Apr. 14, 2023
(86) PCT No.: PCT/IB2023/053846

§ 371 Date: Dec. 3, 2024

(30) Foreign Application Priority Data
Jun. 3, 2022 (CH) 000683/2022

(51) Int. Cl. H01R 13/514; B60L 53/16; B60L 53/30; B60L 53/67; H01R 13/631; H01R 13/73; H01R 25/14; H01R 43/26; H01R 107/00

(52) U.S. Cl. CPC H01R 13/514; B60L 53/16; B60L 53/30; B60L 53/67; H01R 13/631; H01R 13/73; H01R 25/142; H01R 25/145; H01R 43/26; H01R 2107/00; H01R 2201/26

(57) ABSTRACT

A modular charging apparatus for vehicles has a first bar module having first conductor bars electrically powered and extending in a longitudinal extension direction, a charging box having an energy supply group and a connection plug electrically connected to the first conductor bars and to the energy supply group, and a charging socket connectable to the one or more vehicles to allow supplying a charge from the energy supply group to the one or more vehicles. The first bar module is electrically connectable to a second bar module having second conductor bars.

### FIELD OF APPLICATION

The present invention relates to a modular charging apparatus for charging so-called electric plug-in vehicles or hybrid vehicles, and a method for managing the distribution of current by means of an aforesaid modular charging apparatus.

In general, the present invention belongs to the field of electric mobility, and in particular to the field of charging systems for electric or hybrid, plug-in vehicles.

The electric mobility market (cars, motorcycles, scooters, bicycles) is constantly growing. Most advanced economies are actively planning and supporting the ecological transition to overcome or limit the combustion engine.

Therefore, there is an increasing demand for charging points for electric vehicles which allows making the use of such mobility systems more efficient and accordingly increasing the diffusion thereof.

In particular, the need is currently strongly felt to arrange a large number of charging points possibly suitable for providing the power required for charging the vehicle in a quick and efficient manner.

Simultaneously, it is desirable to arrange systems which allow charging a plurality of vehicles in restricted spaces, such as in public or condominium parking lots.

The known systems require the installation of charging columns, each individually connected to the electrical grid by means of a cable harness with cables connecting each charging column to an electrical distribution board.

Such solutions commonly comprise an EVSE (Electric Vehicle Supply Equipment) controller installed in a wallbox or a box of a column fastened to the ground, provided with a socket or cable with a pin.

Disadvantageously, although such solutions are performing, they do not allow implementing further charging stations or removing functionalities over time without intervening on the heart of the system, i.e., the system layout, and they limit the possibilities of repairing and servicing the charging stations themselves.

Disadvantageously, in the known charging systems, if there is the desire to increase the number of charging columns or move the charging columns, it is necessary to perform heavy and costly supplementary maintenance operations such as excavations, building work, and especially cabling.

According to a further disadvantage, the current charging systems are not very efficient and are difficult to scale.

Documents US2017129353A1, CN210363426U, GB1413178A, EP1950850A1, US2020328604A1, CN112224083A, US2022134901A1, WO2010120551A1, US2022242262A1, WO2019147557A1 show certain charging systems and methods relevant to the issue of transmitting current and electric charge of vehicles. The solutions described in such documents do not solve the technical problem addressed by the present invention.

In particular, the aforesaid documents describe solutions having reduced flexibility and do not allow managing a real time distribution of the current in modular systems.

The greatest disadvantage of the systems of the prior art is the impossibility of subsequently inserting new charging points, new columns, unless the above-described electrical part is also installed again. That is, the addition of future columns represents an actual further project with respect to what already exists, and not a simple expansion of the installed base.

### SOLUTION OF THE INVENTION

Therefore, the need is strongly felt to provide a modular charging apparatus and a current distribution management method capable of overcoming the typical drawbacks of the prior art.

In particular, it is the object of the present invention to provide a modular charging apparatus which is simpler and more versatile to construct and manufacture with respect to the known systems.

It is a further object of the present invention to provide a modular charging apparatus which layout is scalable and expandable, reducible or modifiable when required without requiring further installation of electric supply components, excavations and building work, and especially cabling, to be performed.

It is a further aim of the present invention to provide a management method which is effective and adaptable according to the power available, which in particular recognizes the scalability of the system and allows an effective management thereof.

Such a need is met by a modular charging apparatus, the installing, expansion and reduction methods, the charging method and the current distribution management method according to the accompanying independent claims. The claims dependent thereon describe preferred or advantageous embodiments of the invention, involving further advantageous aspects.

### DESCRIPTION OF THE DRAWINGS

The features and advantages of the modular charging apparatus and the management method will become however apparent from the following description of some preferred embodiments thereof, given by way of non-limiting indication, with reference to the accompanying drawings, in which:

FIG. 1 shows a modular charging apparatus according to an embodiment of the present invention, mounted on a wall;

FIG. 2 shows a modular charging apparatus according to an embodiment of the present invention, mounted on a support structure;

FIG. 3 shows a modular charging apparatus according to an embodiment of the present invention, mounted on a wall;

FIG. 4 shows a modular charging apparatus in an embodiment of the present invention, arranged on two levels;

FIG. 5 shows an exploded view of a connecting portion between first conductor bars and second conductor bars, for modular charging apparatus according to an embodiment of the invention, showing electrical connection means and auxiliary isolators;

FIG. 6 shows an exploded view of a connecting portion between first conductor bars and second conductor bars, for a modular charging apparatus according to an embodiment of the invention, showing electrical connection means;

FIGS. 7 and 8 show a side view and a perspective view, respectively, of a junction element in an embodiment of the present invention;

FIG. 9 shows a perspective view of an isolator element in an embodiment of the present invention;

FIG. 10 shows a section of the coupling between a junction element, an isolator element and conductor bars, in an embodiment of the present invention;

FIG. 11 shows an exploded view of a connecting portion between first conductor bars and second conductor bars, for a modular charging apparatus according to an embodiment of the invention, showing auxiliary isolators;

FIG. 12 shows an exploded view of a charging box in an embodiment of the present invention;

FIG. 13 shows a perspective view of a supply group and a connection plug in an embodiment of the present invention;

FIG. 14 shows an enlarged perspective view of a connection socket and a connection plug in an embodiment of the present invention;

FIG. 15 shows a perspective view of a second portion of a load-bearing isolator comprising a connection socket, in an embodiment of the present invention;

FIG. 16 shows a side view of a connection plug in an embodiment of the present invention;

FIG. 17 shows a perspective view of a load-bearing isolator in assembled condition, in an embodiment of the present invention, wherein conductor bars inserted into the respective seats are represented schematically;

FIG. 18 shows a perspective view of a second bar module in which the front profile is separate from the back profile, in an embodiment of the present invention;

FIG. 19 shows an exploded perspective view of an end section of a modular charging apparatus in an embodiment of the present invention, and an enlarged depiction of an electrical connection of said end section to a supply device, in an embodiment of the invention;

FIG. 20 shows an exploded view of a modular charging apparatus in an embodiment of the present invention, wherein for clarity, the supply cables of the conductor bars are not shown.

### DETAILED DESCRIPTION

With reference to the aforesaid drawings, reference numeral 1 indicates overall a modular charging apparatus 1 of one or more vehicles, for charging one or more electric (or hybrid or plug-in) vehicles, such as cars and more generally four-wheel vehicles, motorcycles, scooters, and the like, for example.

According to the invention, the modular charging apparatus 1 comprises a first bar module 11 comprising electrically powered first conductor bars 24 extending in a longitudinal extension direction X.

That is, the first bar module 11 has mainly longitudinal extension in said longitudinal extension direction X.

According to the invention, the modular charging apparatus 1 further comprises a charging box 3 comprising an energy supply group 30 and a connection plug 32 electrically connected to said first conductor bars 24 and said energy supply group 30.

In other words, said connection plug 32 is operatively connected to said energy supply group 30 to transmit energy from said first conductor bars 24 to the energy supply group 30.

The modular charging apparatus 1 further comprises a charging socket 5 connected to said energy supply group 30 and connectable to said one or more vehicles 4 to allow supplying the charge from the energy supply group 30 to such one or more vehicles 4.

According to the invention, the first bar module 11 is electrically connectable to a second bar module 12 comprising second conductor bars 26.

The technical features in the present disclosure which are described for a generic bar module or for a first bar module are also valid and applicable to a second bar module or any additional bar module without loss of generality.

In an embodiment of the present invention, the modular charging apparatus comprises a plurality of electrically connected adjacent bar modules and one or more charging boxes connected thereto. In a further embodiment, the modular charging apparatus comprises one bar module alone and one or more charging boxes connected thereto.

The same applies to the features of generic conductor bars which are applicable to first and second conductor bars and additional conductor bars.

In other words, the modular charging apparatus 1 comprises a kind of “modular track” comprising a conductor bar system for distributing electricity, suitable for supplying one or more charging boxes 3 for electric vehicles 4.

Preferably, the modular charging apparatus 1 is suitable for being installed on a support structure 950, such as a wall of a building, or on a suspended support structure 950, such as a pedestal or stand. Advantageously, the modular charging apparatus is applicable to a variety of distinct situations.

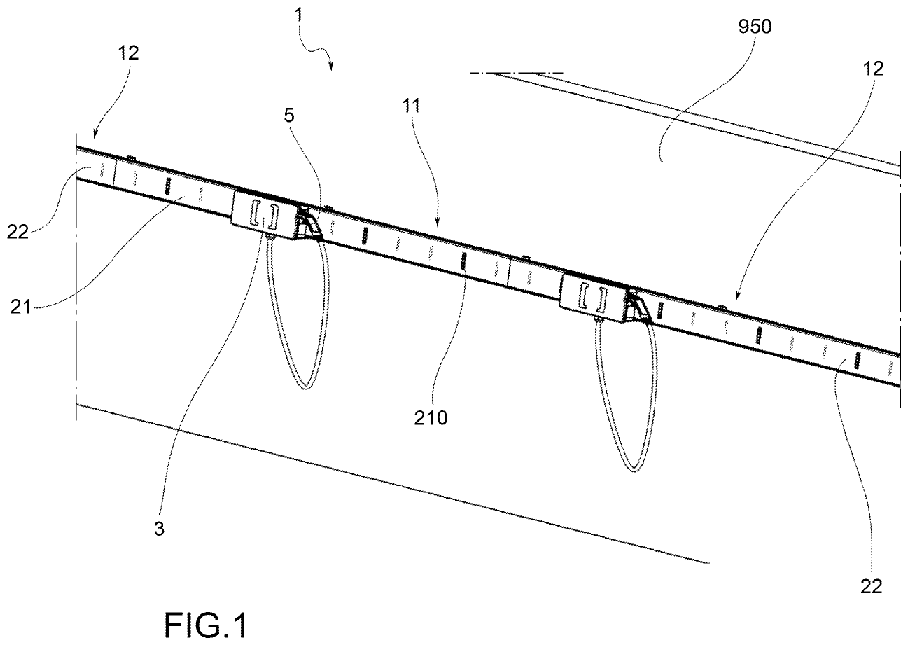

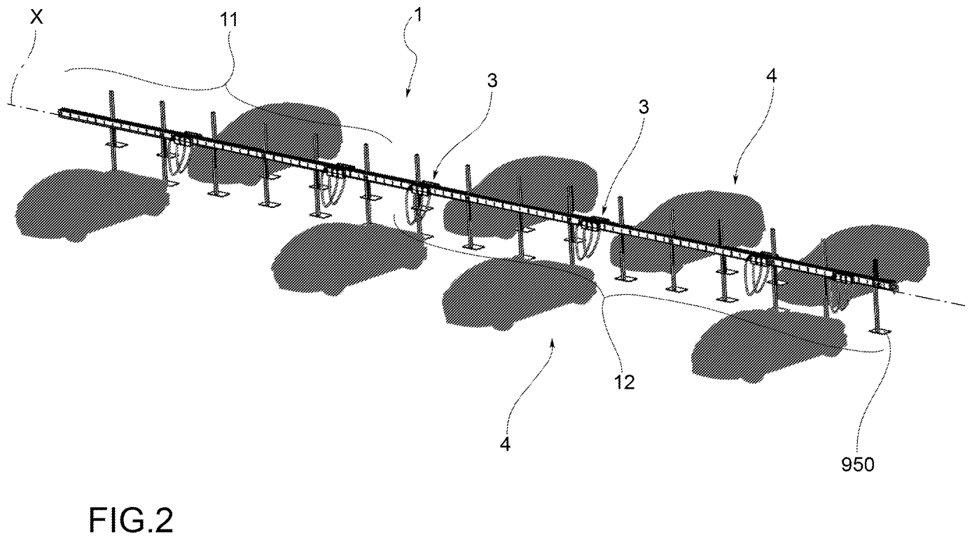

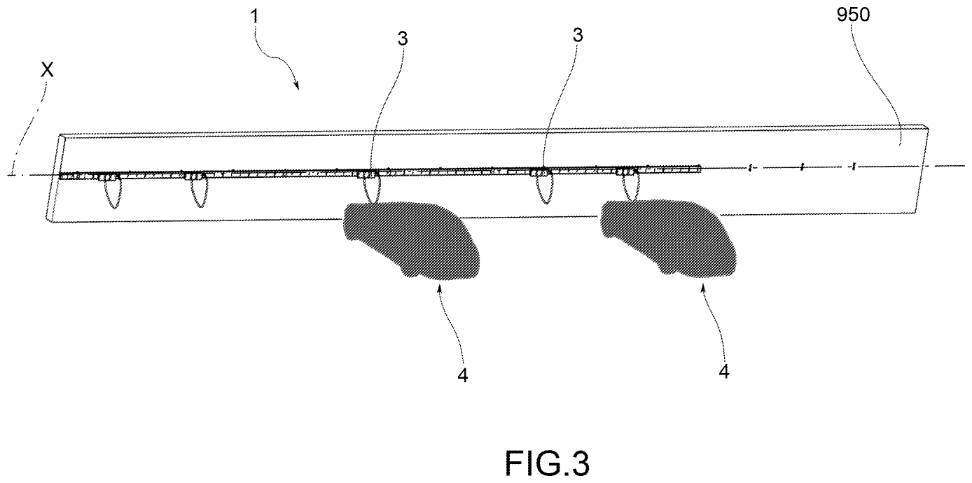

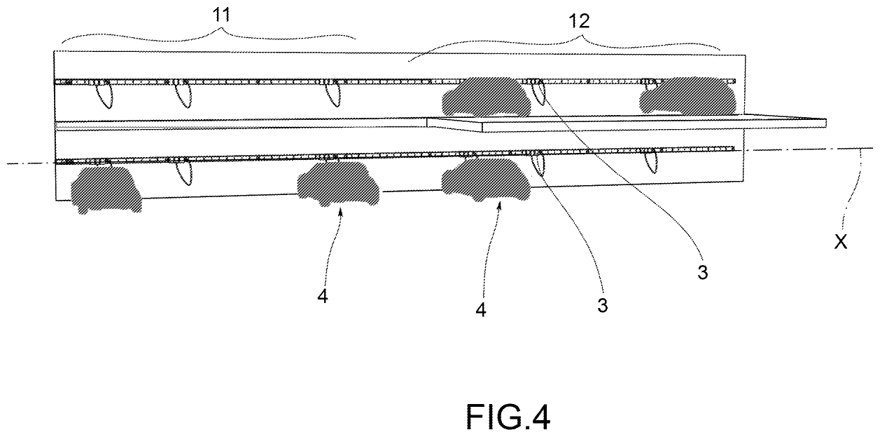

For example, FIGS. 1, 2, 3 and 4 show four embodiments of a modular charging apparatus installed on a wall (FIGS. 1 and 3) or on a support structure 950 having modular charging apparatuses installed on two sides so as to serve two rows of adjacent vehicles (FIG. 2), or wall-mounted on two levels (FIG. 4).

Preferably, the conductor bars 24, 26 support a three-phase system. That is, there are four conductor bars, one for each phase and one for neutral (ground).

Preferably, the first and/or second conductor bars 24, 26 are made of metal, for example of aluminum or copper.

Preferably, the first and/or second conductor bars 24, 26 are obtained by extrusion.

Preferably, the conductor bars 24, 26 are parallel to each other in the longitudinal extension direction X.

According to an embodiment, the conductor bars 24, 26 are made in a predetermined length, preferably two meters, preferably three meters.

Preferably, the conductor bars 24, 26 can be made in varying length according to application and transport needs. For example, the conductor bars are made in a length suitable for being stored in containers and means of transport having standard dimensions.

Advantageously, the modular charging apparatus is scalable and allows the easy transport of the components thereof.

Preferably, the modular charging apparatus 1 comprises a multitude of charging boxes 3 connected to the conductor bars 24, 26 by means of said connection plug 32.

Advantageously, the modular charging apparatus is suitable for receiving a plurality of charging boxes in electrical connection, and such charging boxes are positionable in varying points in the longitudinal extension of the conductor bars 24, 26.

Advantageously, the charging box 3 is connectable to the conductor bars 24, 26 in any point of the longitudinal extension thereof in the longitudinal extension direction X.

In an embodiment, the modular charging apparatus 1 comprises a second bar module 12 adjacent to the first bar module 11 in the longitudinal extension direction X. Preferably, the modular charging apparatus 1 comprises a plurality of successive second bar modules 12, preferably adjacent to one another.

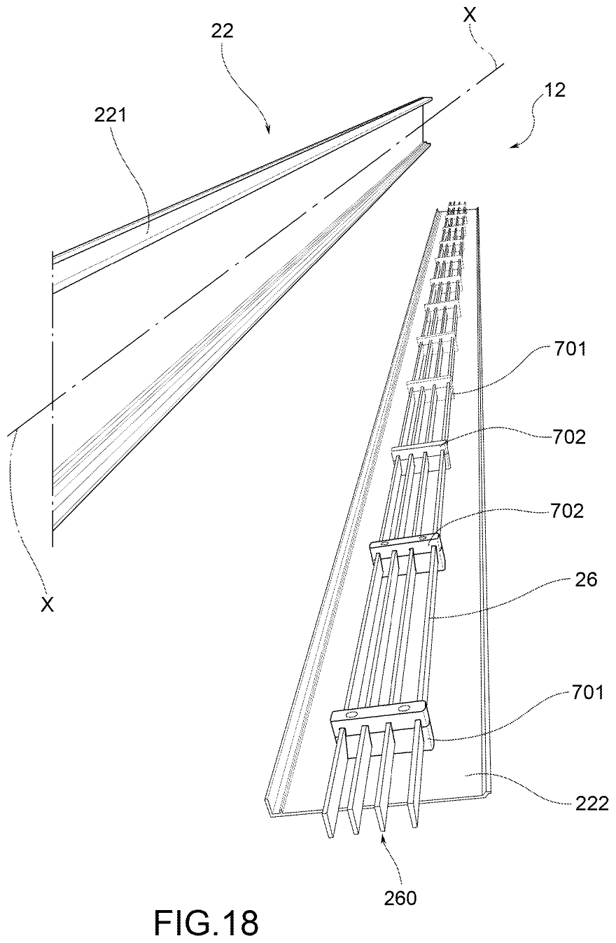

The second bar module 12 comprises second conductor bars 26. An example of open second bar module is shown in FIG. 18.

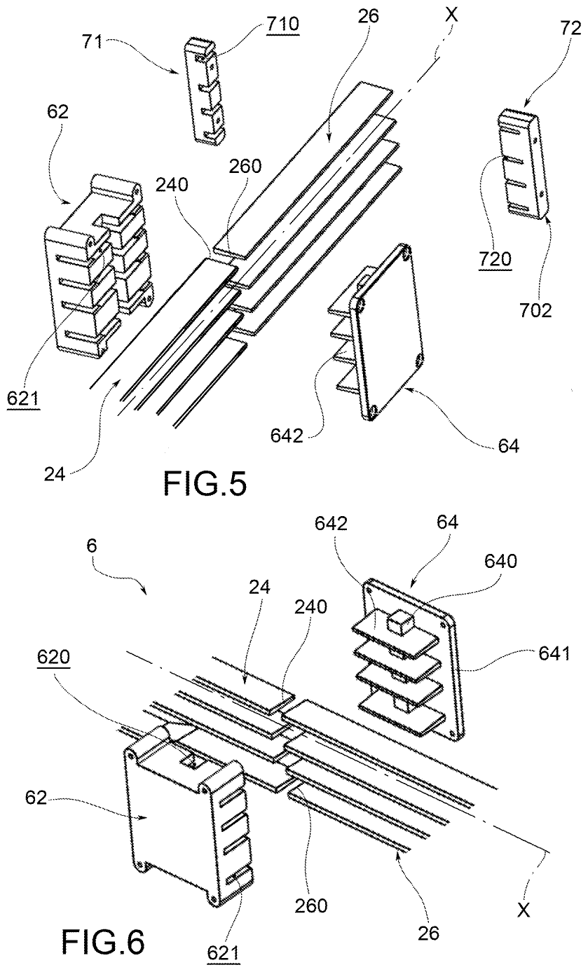

In an embodiment, as shown in FIGS. 5, 6, and 10, for example, the modular charging apparatus 1 comprises electrical connection means 6 which electrically mutually connect said second conductor bars 26 to said first conductor bars 24, allowing the passage of electric current.

It is apparent that the description in the present disclosure concerning the connection between a first bar module and a second bar module is true for the connection between the first or the second bar module and further additional bar modules.

For example, in an embodiment, the modular charging apparatus comprises five bar modules, in which each bar module is mechanically and electrically connected to the adjacent bar module according to what is described for the connection between a first and second bar module.

In an embodiment, the first conductor bars 24 comprise a first connection end 240 and the second conductor bars 26 comprise a second connection end 260.

Preferably, such connection ends 240, 260 are suitable for facing one another in connection step between the first bar module 11 and the second bar module 12.

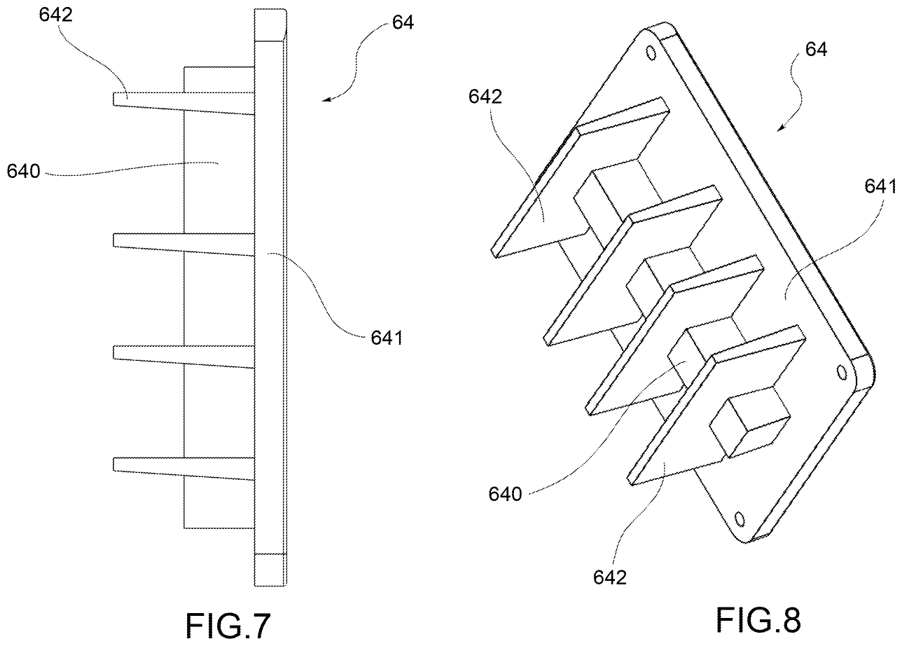

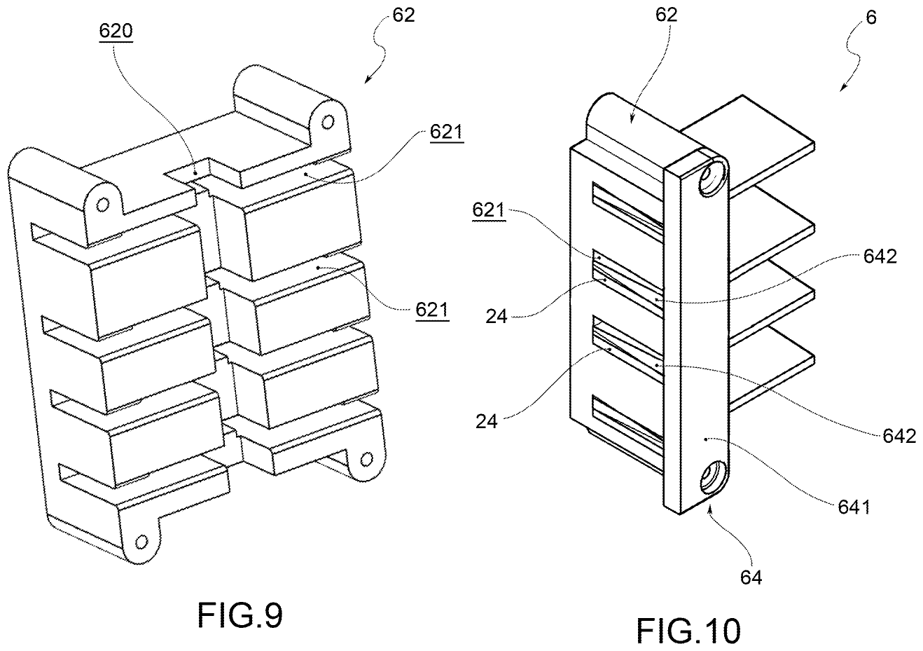

In an embodiment, the electrical connection means 6 comprise at least one isolator element 62 and at least one junction element 64, shown in FIGS. 6, 7, 8 and 9, for example.

Apposite bar seats 621 suitable for receiving the conductor bars 24, 26 at said first connection end 240 and said second connection end 260 while keeping them spaced apart from each other, are obtained in said at least one isolator element 62.

Preferably, the bar seats 621 are grooves or prismatic recesses and are equal in number to the number of conductor bars of each module. Preferably, the bar seats are four parallel grooves in the longitudinal extension direction X.

Said at least one junction element 64 comprises joint conductor bars 642 suitable for being inserted into the bar seats 621 at least partially overlapping said first conductor bars 24 and said second conductor bars 26 at said first connection end 240 and second connection end 260.

Said joint bars 642 are suitable for generating contact and force coupling with said first conductor bars 24 and second conductor bars 26 so as to ensure good electrical contact.

The isolator element is preferably made of self-extinguishing plastic material.

Advantageously, the modular charging apparatus 1 is expandable in the longitudinal extension direction X by means of the simple and intuitive subsequent connection of a plurality of successive bar modules.

This allows avoiding costly excavation, installing, cabling, building work and maintenance operations which would be required to expand a charging System for vehicles according to the prior art.

Preferably, the number of joint bars 642 is the same to the number of conductor bars of each bar module.

In an advantageous embodiment, the conductor bars 24, 26 have a trapezoid-shaped cross section on a plane orthogonal to said longitudinal extension direction X.

Preferably, said cross section is in the shape of an isosceles trapezoid.

Alternatively, said cross section is in the shape of a rectangular trapezoid.

Preferably, the minor base of said trapezoids faces the user, i.e., towards the front of the modular charging apparatus.

In an embodiment, the joint bars 642 have a trapezoid-shaped cross section, preferably in the shape of an isosceles or rectangular trapezoid, on a plane orthogonal to the longitudinal extension direction X.

In an advantageous embodiment, the cross section of the joint bars 642 mirrors the cross section of the first and second conductor bars 24, 26 so that a geometric force coupling is generated in the overlapping between the joint bars 642 and the first and second conductor bars 24, 26, between the planes inclined with different inclinations therebetween.

The term “mirrors” means that the joint bars 642 are shaped to face the minor base of the trapezoid of the cross section thereof, towards the minor base of the trapezoid of the cross section of the conductor bars, in mounting step.

In other words, the trapezoidal section of the joint bars 642 and the trapezoidal section of the conductor bars 24, 26 are inverted, i.e., under mounting condition, the conductor bars 24, 26 and the joint bars 642 overlap “in a ramp”, generating optimal pressure contact.

Advantageously, the above-described trapezoidal section ensures an optimal electrical connection, exploiting the so-called “wedge” insertion generating pressure. Such an embodiment allows obtaining the electrical connections while avoiding the use of elastic elements which could compromise the quality of the contact in the long run.

In a preferred embodiment, the cross section of the joint bars 642 has rounded edges to facilitate the sliding of the joint bars 642 on the conductor bars 24, 26.

In an embodiment, also the conductor bars 24, 26 have a cross section with rounded edges.

In an embodiment, the junction element 64 comprises a closing plate 641 made of insulating material, preferably self-extinguishing insulating material, which comprises an insulating prismatic portion 640, projecting from said closing plate 641 and comprising bar seats in which said joint conductor bars 642 are engaged.

Preferably, the prismatic portion 640 has preferential extension in a direction orthogonal to the joint bars 642. The prismatic portion serves the function of keeping the connection ends 240, 260 longitudinally spaced apart from each other.

In an embodiment, the isolator element 62 has a prismatic coupling seat 620 geometrically engaged with said prismatic portion 640 of the junction element 64.

In other words, the isolator element 62 is a support base which receives the conductor bars 24, 26 from the back (i.e., in an embodiment, on the side of the major base of the trapezoid), keeping them mutually spaced apart and parallel, and the junction element 64 is a cover provided with joint bars, in turn conductor bars, suitable for acting as a bridge for the passage of electric current between the first conductor bars 24 and the second conductor bars 26.

Preferably, when mounted, the junction element 64 is firmly fastened to the isolator element by means of external fasteners such as screws or pins.

Preferably, the joint conductor bars 642 are engaged in the bar seats of the prismatic portion 640 in a mutually spaced apart and projecting manner.

Preferably, the closing plate 641 and the prismatic portion 640 are made of self-extinguishing plastic material.

Preferably, the joint bars are made of aluminum or copper. Preferably, they are sections of conductor bars. Preferably, they are sections of metal extrudates.

In an embodiment, at least one of the first bar module 11 and the second bar module 12 comprises isolators 7 made of insulating material, which are suitable for keeping the first conductor bars 24 and/or the second conductor bars 26, respectively, spaced apart and substantially parallel to each other for the extension thereof in the longitudinal extension direction X.

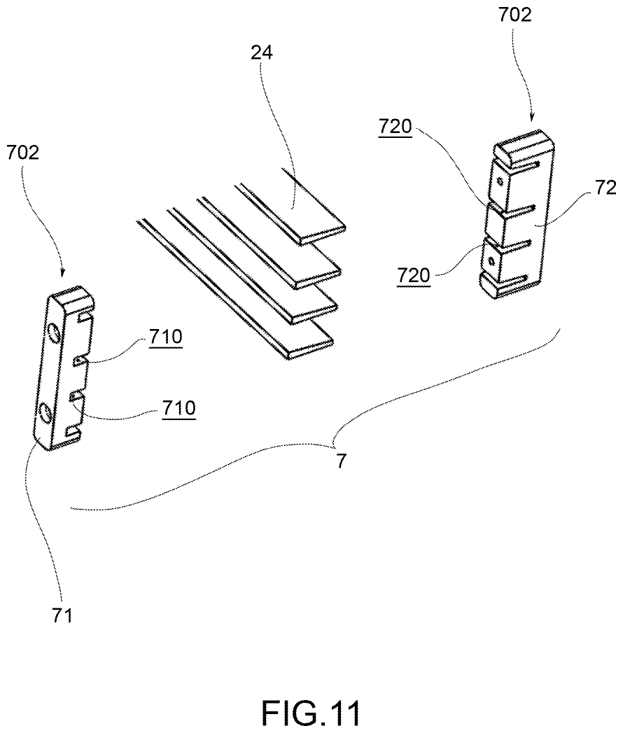

Preferably, both the first bar module 11 and the second bar module 12 comprise isolators 7, shown in the embodiments in FIGS. 5 and 11, for example.

In an embodiment, the bar module 11, 12 comprises a series of isolators 7 placed at an equal and preset distance from one another.

In an embodiment, said isolators 7 each comprise a first rear isolator portion 71 and a second front isolator portion 72.

Each of such first and second isolator portions 71, 72 has respective grooves 710, 720, each having prevailing extension parallel to the longitudinal extension direction X.

Said first isolator portion 71 and said second isolator portion 72 are mutually engageable (engaged) so that the respective grooves 710, 720 match to create a seat suitable for engaging the first conductor bars 24 and/or the second conductor bars 26 by shape coupling.

Preferably, said seat has a trapezoid cross section, even more preferably, a trapezoid isosceles or trapezoid rectangle cross section.

In other words, the grooves, matching by virtue of the engagement between the isolator portions, form a seat having a cross section on a plane perpendicular to the longitudinal extension direction X so as to receive and block the conductor bars 24, 26.

Preferably, the first isolator portion 71 can be fastened to the second isolator portion 72 by means of pins or screws.

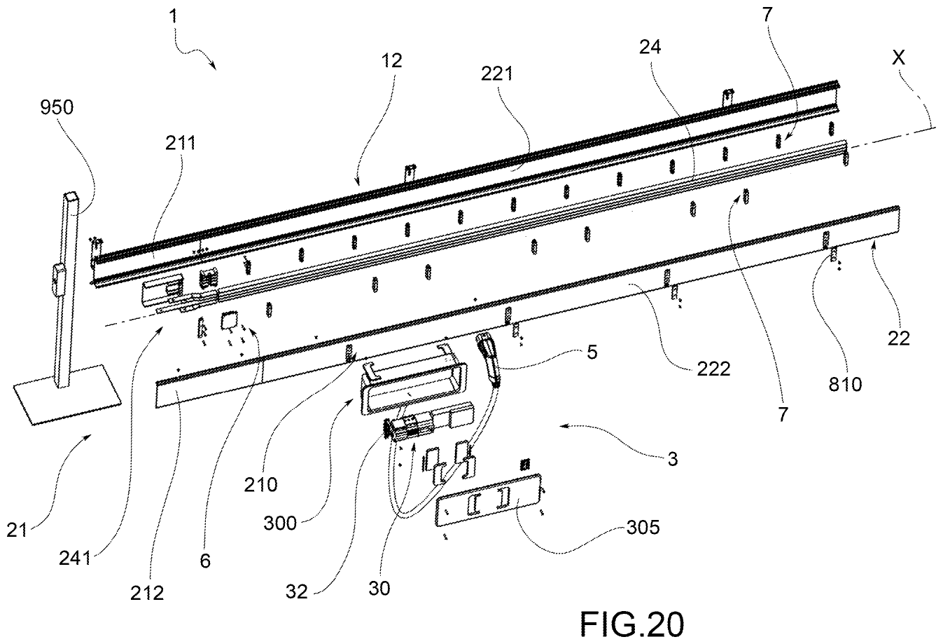

In an embodiment, at least one of the first bar module 11 and the second bar module 12 comprises a casing 21, 22 which encloses the first 24 and/or second 26 conductor bars. The casing is shown in the embodiments in FIGS. 18 and 20, for example.

Preferably, the first bar module 11 comprises a first casing 21 and the second bar module comprises a second casing 22.

In an embodiment, the isolators 7 are suitable for keeping said first conductor bars 24 and/or second conductor bars 26 spaced apart from casing 21, 22 to isolate said first conductor bars 24 and/or said second conductor bars 26 from casing 21, 22 and/or avoid the creation of heat bridges.

Preferably, casing 21, 22 is a prefabricated casing, preferably made of folded sheet metal or an extrudate.

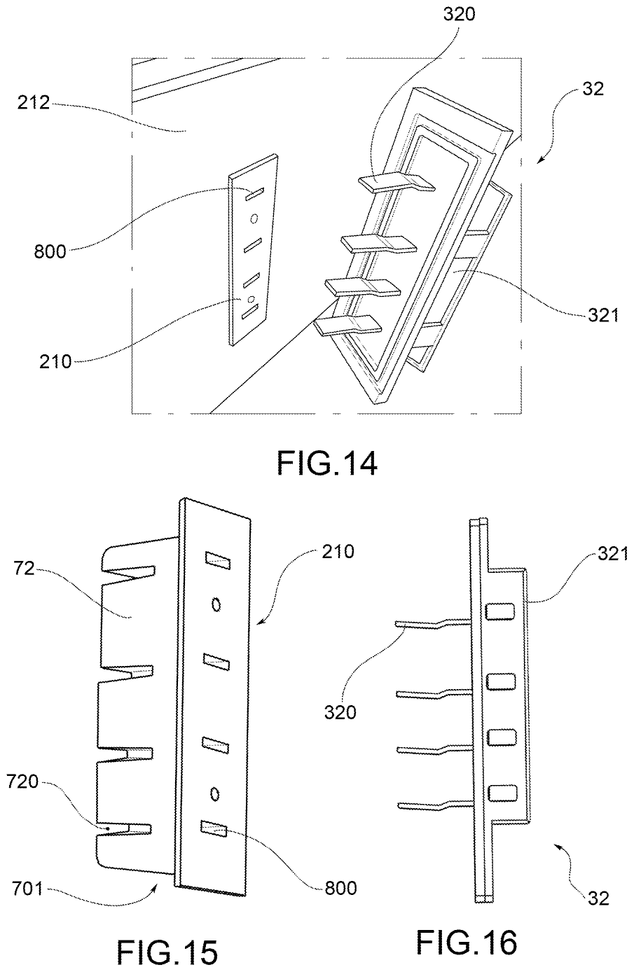

In an embodiment, with reference to FIGS. 14 and 15, the modular charging apparatus 1 comprises one or more connection sockets 210 suitable for allowing the electrical connection between the connection plug 32 of one or more charging boxes 3 and the first conductor bars 24 and/or the second conductor bars 26.

Preferably, socket seats in which said connection sockets 210 are accommodated, are obtained in casing 21, 22.

According to an advantage of the invention, the socket seats are obtained in any point of the longitudinal extension of casing 21, 22 in the longitudinal extension direction X, as shown in FIG. 20.

Advantageously, the use of conductor bars allows providing the seats (and the sockets) for the connection of the charging boxes in any point of the longitudinal extension of the modular charging apparatus.

This gives the modular charging apparatus increased flexibility and allows the user to easily modify the installation layout of the modular charging apparatus as needed.

In the present disclosure, the term “front” or “frontal” or “anterior” mean components which, in the modular apparatus, with respect to the conductor bars, are on the side of the user, i.e., on the side of track intended for the attachment of the charging box. Vice versa, the terms “back” or “rear” mean components which, in the modular apparatus, with respect to the conductor bars, are on the opposite side with respect to the user, for example towards a wall on which the track is installed.

In an advantageous embodiment, casing 21, 22 comprises:
a back profile 211, 221 suitable for being fastened to a wall or a pedestal or a support structure 950, and
a front profile 212, 222 suitable for facing a user, for example.

Such a back profile 211, 221 and such a front profile 212, 222 are engaged to each other, preferably geometrically coupled with snap coupling, to form casing 21, 22 so as to contain said first 24 and/or second 26 conductor bars, to create an airtight casing, for example.

In an embodiment, the isolator element 62 is fastened to the back profile 211, 221 of casing 21, 22. Thereby, the isolator element serves as support element for the conductor bars 24, 26.

In an advantageous embodiment, the back profile 211, 221 is a metal section bar having “C”-shaped cross section on a plane orthogonal to the longitudinal extension direction X.

Advantageously, such an embodiment gives the casing optimal seal against humidity, in compliance with current legislation.

Preferably, the back profile 211, 221 has a snap coupling portion and the front profile 212, 222 has a counter-snap coupling portion which can be engaged with said snap coupling portion.

Preferably, the front profile 212, 222 is a substantially planar cover.

In an advantageous embodiment, the socket seats are obtained in the front profile 212, 222.

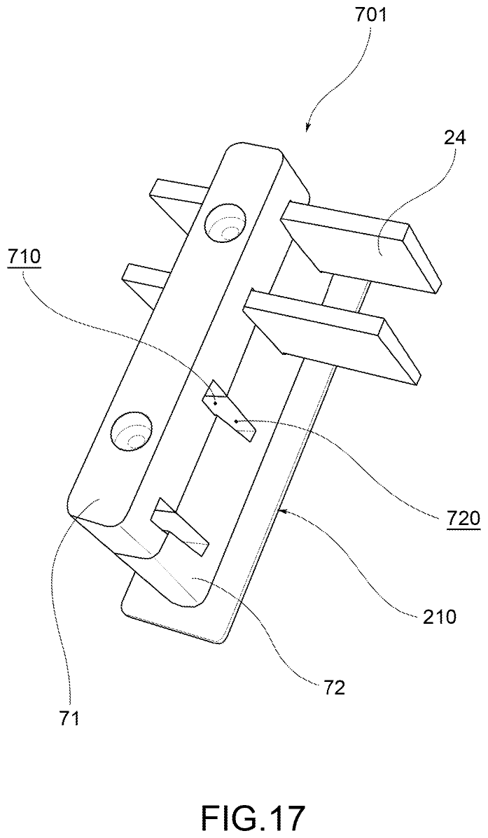

In an embodiment and with reference to FIGS. 15 and 17, the isolators 7 comprise one or more load-bearing isolators 701 at least partially fastened to casing 21, 22 so as to support and keep suspended the first and second conductor bars 24, 26 and keep them integral with casing 21, 22.

Preferably, as shown in FIG. 18, for example, such one or more load-bearing isolators 701 are at least partially fastened to the front profile 212, 222.

Even more preferably, it is the second isolator portion 72 to be fastened to said front profile 212, 222. Preferably, the fastening is by snap coupling, bayonet coupling, gluing or fastening by means of screws.

Such an embodiment advantageously allows “prefabricating” a part of the modular charging apparatus comprising at least the front profile of the casing and conductor bars, supported by the load-bearing isolators, and minimizing the on-site mounting operations for lengthening the modular charging apparatus, the on-site mounting only involving the electrical coupling between an additional bar module and a bar module already installed, by means of the electrical connection by means of the aforesaid electrical connection means, and possibly fastening the front profile to the back profile of the casing.

In an embodiment, the isolators 7 comprise only auxiliary isolators 702 exclusively engaged in the first and/or second conductor bars 24, 26 and independent of, i.e., separate from, released from, autonomous of, casing 21, 22.

In an advantageous embodiment, as shown in FIG. 15, for example, the load-bearing isolators 701 comprise the connection sockets 210.

In other words, in such an embodiment, the connection sockets 210 are integrated in said load-bearing isolators 701.

Preferably, the connection sockets 210 coincide with the load-bearing isolators 701.

In an embodiment, with reference to FIGS. 14 and 15, the one or more connection sockets 210 comprise slits 800 adapted to allow access to conductor blades 320 of a connection plug 32 and promote the contact thereof with the first or second conductor bars 24, 26.

In preferred embodiment, the modular charging apparatus 1 includes sealing cover elements 810 suitable for closing said connection sockets 210 when not being used. Advantageously, such cover elements 810 maintain the safety of the users, avoiding undesired contact with the electrical connections and the conductor bars.

Preferably, such cover elements 810 are covers firmly screwed to the connection sockets 210 according to the current safety legislation.

In an embodiment, with reference to the example in FIGS. 14 and 16, the connection plug 32 comprises conductor blades 320 suitable for being inserted into said one or more connection sockets 210 for coming into contact with the first or second conductor bars 24, 26 and for generating an elastic force pressing on said first or second conductor bars 24, 26. For example, said conductor blades 320 protrude in cantilevered manner from a pin body 321, or protrude with a “step” or “overturned S” cross section.

In an embodiment, the conductor blades 320 have a cross section on a plane orthogonal to the longitudinal extension direction X in the shape of a step, and are suitable for being inserted into said one or more charging sockets 210 to generate elastic electrical contact force pressing on the first or second conductor bars 24, 26 and transmit current to the supply group 30.

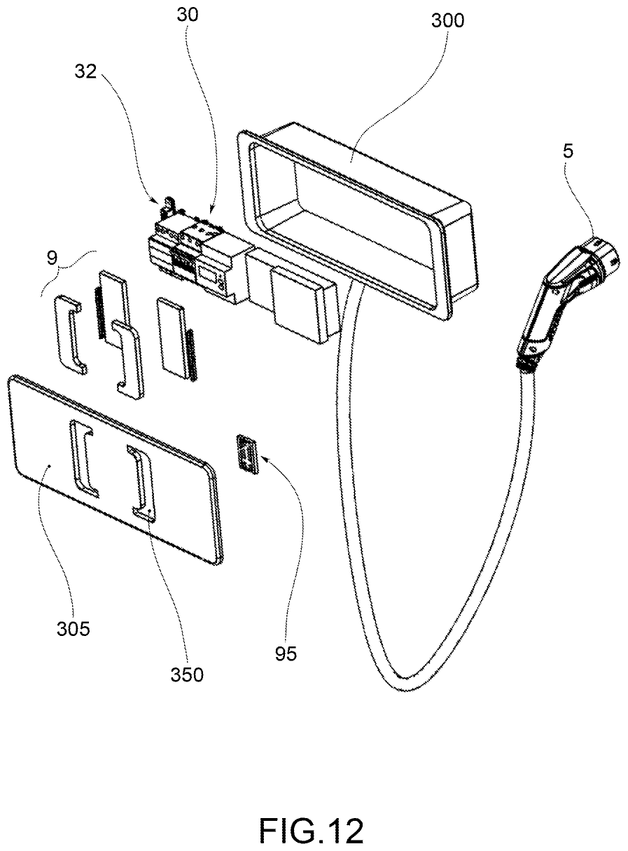

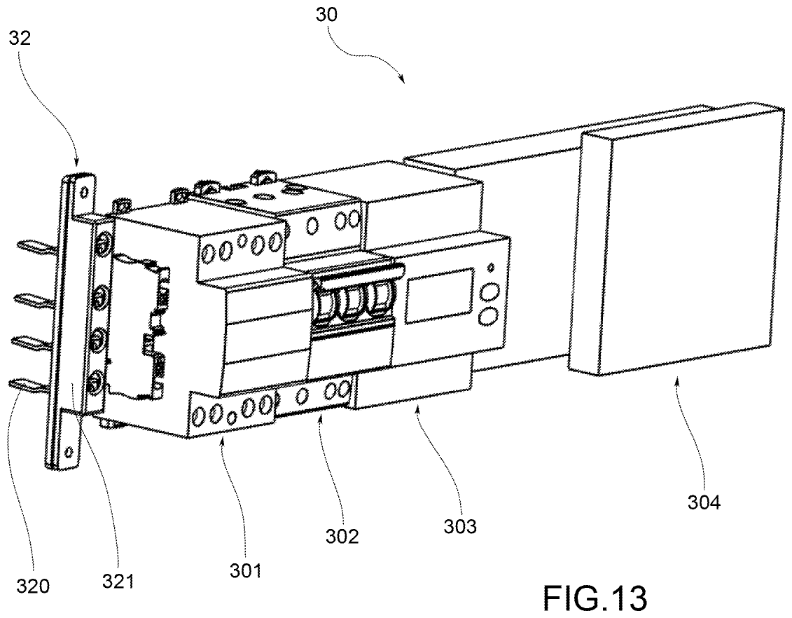

In an embodiment, with reference to FIG. 12, the charging box 3 comprises a containment box 300 which accommodates the supply group 30, shown in an embodiment in FIG. 13.

Preferably, the supply group 30 comprises a supply management relay 301.

In an embodiment, the supply group comprises a safety switch 302.

The Safety switch 302 is configured to protect the supply group 30 from overload and short-circuit currents.

Preferably, the safety switch 302 is configured to automatically cut (i.e., without external intervention) the flow of electric current in the event of an overload.

In a preferred embodiment, the safety switch 302 is a magnetothermal switch.

In an advantageous embodiment, the supply group comprises a supply meter 303, preferably a smart meter, configured to record and save the amount of energy supplied by the supply management relay 301.

In an embodiment variant, the supply group comprises an electronic board 304.

In an embodiment, the supply management relay 301 is configured to actuate or block the charge supply to the vehicle according to a signal received from the electronic board 304.

In an embodiment, the electronic board 304 is configured to recognize the presence of vehicle 4, transmit a start charge signal, modulate the charge supply and terminate the supply once charging is complete.

In an embodiment, the supply group comprises a user interface connected to said electronic board 304 and suitable for being set by a user to define a series of work parameters, such as the number of modular tracks, the number of charging boxes, the limit of current which can be drawn from each modular track, the IP address of each box connected, the maximum current limit which can be drawn from the grid, the existing connection method, for example Ethernet, Wi-Fi, Lora, powerline.

In an embodiment, the modular charging apparatus 1 comprises a central control unit.

Preferably, the central control unit is configured to communicate with the electronic board 304 of each charging box 3 installed on the conductor bars 24, 26.

In an embodiment, the central control unit is electronically connectable to the supply group 30 by means of a LAN connection (“Local Access Network”).

Preferably, a LAN port for the connection of the supply group 30 to the central electronic control unit is obtained in casing 21, 22.

The supply meter 303 is configured to detect the data on the energy consumption for supplying the charge and simultaneously send such consumption data to the central control unit in real time.

The central control unit is configured to manage the distribution of the energy to each supply group 30 connected to the conductor bars 24, 26 according to the data transmitted by said supply meter 303.

In an embodiment, the connection between the supply meter 303 and the central control unit is by Wi-Fi.

In an alternative embodiment, the connection between the supply meter 303 and the central control unit occurs by means of data cables, preferably connected to an intermediate centralized connection channel (a bus) accommodated in the modular track 2.

In an embodiment, the modular charging apparatus 1 comprises a general supply device and conductor Cables which electrically connect said general supply device to the first and/or second conductor bars 24, 26.

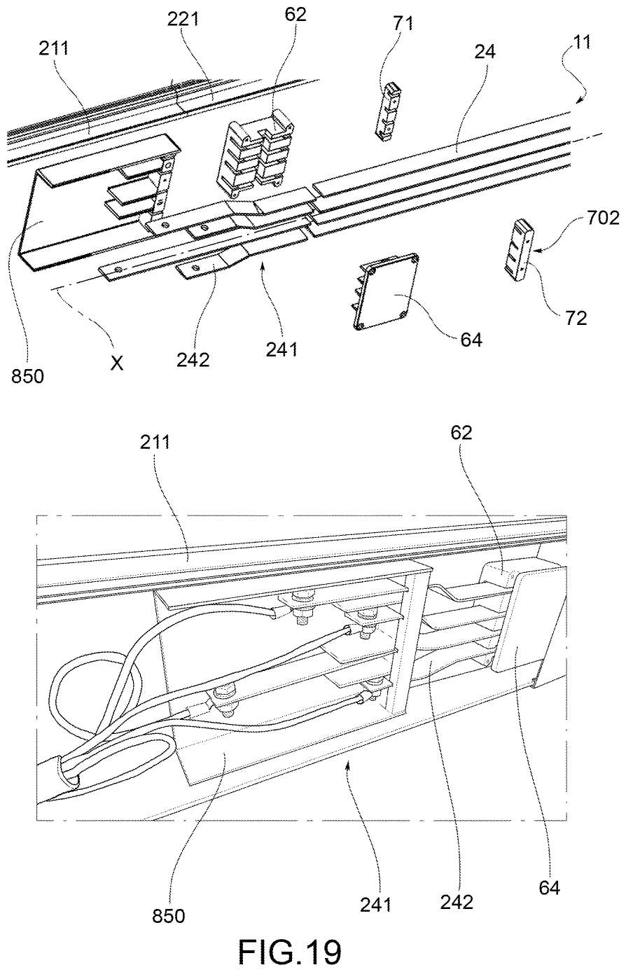

In an embodiment, with reference to FIG. 19, the modular charging apparatus 1 comprises an end section 241 connected to the general supply device to receive electric current, said end section 241 in turn comprising end conductor bars 242.

In an embodiment, the end section 241 is other from the first and second bar module 11, 12 and the end conductor bars 242 are electrically connected to the first or second conductor bars 24, 26 by means of electrical connection means 6.

Preferably, said electrical connection means 6 are the same electrical connection means 6 described in the present disclosure for the connection between the first bar module 11 and the second bar module 12.

Preferably, also the end section is enclosed in a casing 21.

In an embodiment, the end section 241 is connected to the supply device by means of electric cables with an eyelet terminal, which are tightened on each bar of said end conductor bars 242, for example by means of bolts inserted into special holes provided at the ends of said end section 241.

Preferably, the end section 241 is further enclosed inside an insulating supply box 850 which is suitable for keeping isolated the connection between the end conductor bars 242 and the supply device.

Preferably, the modular charging apparatus 1 is provided with an electronic supply group configured to communicate with the central control unit and with the electronic board 304 of each charging box 3 connected to the conductor bars 24, 26.

The modular charging apparatus 1 further comprises a sensor configured to detect the presence of each charging box 3 and the electrical parameters thereof, such as power parameters.

The supply meter 303 is further configured to identify the corresponding charging box 3 by means of a unique identification recognition code and the central control unit is configured to record said unique identification code.

In other words, each charging box 3 is identified by means of a unique identification recognition code of the respective supply meter 303 and such a unique identification recognition code can be saved by the central control unit.

Preferably, said unique identification code is an IP address.

In an embodiment, the charging box 3 comprises a recognition sensor, such as an RFID reader (Radio Frequencies Identification) 95, configured to recognize an RFID device of a user authorized to proceed with the charging operation.

In an embodiment, the containment box 300 is closed at the front by a front head 305.

In an embodiment, the charging box 3 comprises a light device 9 operatively connected to the supply group 30 to be activated to emit light according to the status of the supply group 30.

Preferably, the light device 9 is configured to emit colored light in the colors belonging to the visible spectrum.

Openings 350 suitable for allowing the visibility of the light emitted by the light device 9 are obtained in the front head 305.

The present invention also relates to a method for installing a modular charging apparatus 1 according to the present invention.

The installing method comprises the following steps:
a) providing:
   a support structure 950, such as a pedestal or a wall;
   a first bar module 11 comprising first conductor bars 24;
   a charging box 3 electrically connectable to the first conductor bars 24;
b) fastening the first bar module 11 to said support structure 950 so that the bar module 11 extends in a longitudinal extension direction X;
c) connecting the charging box 3 to the first bar module 11 at any point of the extension of the first bar module 11 in the longitudinal direction X, creating an electrical connection between the charging box 3 and said first conductor bars 24.

Preferably, the electrical connection between the charging box 3 and the first bar module 11 occurs by means of electrical contact between the connection plug 32 of the charging box 3 and the conductor bars 24.

In an embodiment, the installing method comprises the following steps:
d) providing a second bar module 12 comprising second conductor bars 26;
e) providing electrical connection means 6 adapted to electrically connect said first conductor bars 24 and said second conductor bars 26;
f) placing the second bar module 12 adjacent to the first bar module 11 in the main extension direction X;
g) electrically connecting said first conductor bars 24 to said second conductor bars 26 by means of said electrical connection means 6.

In an embodiment, the electrical connection means 6 comprise:
an isolator element 62 in which bar seats 621 are obtained which at least partially receive the first conductor bars 24 and are suitable for receiving at least partially the second conductor bars 26;
a junction element 64 comprising joint conductor bars 642 suitable for being inserted into the bar seats 621 at least partially overlapping said first 24 and second 26 conductor bars and suitable for generating contact and force coupling therewith so as to ensure good electrical contact.

According to such an embodiment, step g) comprises the following sub-steps:
g1) at least partially inserting the second conductor bars 26 into the bar seats 621;
g2) inserting the joint bars 642 into the bar seats 621 and generating force coupling with the first and second conductor bars 24, 26.

The present invention relates to a method for expanding a modular charging apparatus 1 according to the present invention, comprising the following steps:
a) providing a modular charging apparatus 1 according to the present invention, and an additional bar module;
b) connecting the first bar module 11 or the second bar module 12 to said additional bar module according to steps e), f) and g) of the installing method.

The present invention relates to a method for reducing a modular charging apparatus 1 according to the present invention, comprising a first bar module 11 and a second bar module 12, comprising the following steps:
a) removing the electrical connection means between the second bar module 12 and the first bar module 11;
b) removing the second bar module 12 from the modular charging apparatus 1.

The present invention also relates to a method for distributing current to a modular apparatus 1 according to the present invention.

Such a method includes the following steps:
a) providing a modular charging apparatus 1 according to the present invention;
b) providing an electronic supply group and a power sensor which are operatively connected to the conductor bars 24, 26 and a central control unit;
c) on the power sensor, detecting a first power data required by each bar module;
d) on the electronic supply group, comparing the required power data with a predetermined maximum available power parameter;
e1) if the required power data is less than the maximum available power, on the central control unit, dividing the required power among the charging boxes 3 connected to a respective vehicle 4; or
e2) if the required power data is greater than the maximum available power, setting as default the required power data as the maximum available power and dividing such a maximum available power among the charging boxes 3 connected to a respective vehicle 4.

In an embodiment, step e1) includes equally distributing the required power among each of the charging boxes 3 connected to a respective vehicle 4.

In an embodiment, step e2) includes equally distributing the maximum power among each of the charging boxes 3.

In an alternative embodiment, step e2) includes blocking the supply of energy to one or more of the charging boxes 3 activated first in terms of time, and dividing the maximum available power among the remaining charging boxes which were activated in a subsequent moment.

In such an embodiment, the central control unit acts with the supply meter 303 of each charging box, which is configured to also measure the time interval which transpired from the connection of the vehicle to the charging box 3, and identifies the charging boxes 3 activated the longest, temporarily deactivating them.

The number of charging boxes 3 to be deactivated is processed by the central control unit on the basis of the maximum available power or is set by the user as a fixed parameter.

Vice versa, in a still further embodiment, step e2) includes blocking the supply of energy to the last boxes to have been activated, and divides the maximum available power among the remaining charging boxes, to complete the charging thereof.

The present invention also relates to a method for charging a vehicle by means of a modular apparatus 1 according to the present invention, comprising the following steps:
a) providing a modular charging apparatus 1 according to the present invention;
b) connecting the charging socket 5 to a vehicle 4 and transmitting a supply requirement to the supply group 30;
c) on the supply group 30, transmitting a work signal to the central control unit of the modular charging apparatus 1;
d) on the central control unit, checking that the power required by the vehicle 4 is less than the power which can be collected from the grid;
e) from the central control unit, sending a system supply command to conductor bars 24 to supply the supply box 3 with the power required by the vehicle 4;
f) on the supply group 30, allowing the supply of the current to the vehicle by means of the charging socket 5.

Innovatively, the present invention solves the drawbacks of typical charging systems of the prior art.

Advantageously, the modular charging apparatus according to the present invention simplifies the engineering operations and is scalable for possible expansion.

According to a further advantage, the modular charging apparatus according to the present invention is suitable for being expanded to include a further charging station by means of quick intervention and does not require the intervention of skilled technicians to implement engineering modifications at the cabling level.

Advantageously, the modular charging apparatus according to the present invention comprises all the technical equipment required in the prefabricated item industry.

According to a further advantage, the modular charging apparatus allows dynamically monitoring the charging of the electric vehicles and is suitable for being adapted to the device connected and to the power to be supplied.

According to a still further advantage, the management method allows complete remote control of the individual charging station and the related data analysis.

It is apparent that in order to meet specific needs, those skilled in the art may make variations to the embodiments of the aforesaid modular charging apparatus and the aforesaid management method or replace elements with others which are functionally equivalent.

Such variations are also contained in the scope of protection as defined by the following claims. Furthermore, each variation described as belonging to a possible embodiment can be implemented irrespective of the other variations described.

1-53. (canceled)

54. A modular charging apparatus for charging one or more vehicles, optionally the one or more vehicles being electric, hybrid, or plug-in vehicles, the modular charging apparatus comprising:
a first bar module comprising first conductor bars that are electrically powered and extend in a longitudinal extension direction;
a charging box comprising an energy supply group and a connection plug electrically connected to the first conductor bars and the energy supply group; and
a charging socket connected to the energy supply group and connectable to the one or more vehicles to allow a charge to be supplied from the energy supply group to the one or more vehicles, wherein the first bar module is electrically connectable to a second bar module comprising second conductor bars.

55. The modular charging apparatus of claim 54, further comprising a second bar module adjacent to the longitudinal extension direction, the second bar module comprising second conductor bars, wherein the modular charging apparatus still further comprises electrical connection means that electrically mutually connect the second conductor bars to the first conductor bars, allowing passage of electric current.

56. The modular charging apparatus of claim 55, wherein the first conductor bars comprise a first connection end and the second conductor bars comprise a second connection end, wherein the electrical connection means comprise at least one isolator element and at least one junction element, wherein bar seats suitable for receiving the first connection end and the second connection end while keeping the first connection end and the second connection end spaced apart from each other, are formed in the at least one isolator element, and wherein the at least one junction element comprises joint conductor bars adapted to be inserted into the bar seats at least partially overlapping the first conductor bars and the second conductor bars at the first connection end and second connection end and suitable for generating contact and force coupling with the first conductor bars and the second conductor bars so as to ensure good electrical contact.

57. The modular charging apparatus of claim 55, wherein the first conductor bars and the second conductor bars have a trapezoid-shaped cross section on a plane orthogonal to the longitudinal extension direction, preferably an isosceles trapezoid shape or a rectangular trapezoid shape.

58. The modular charging apparatus of claim 57, wherein a cross section of the joint conductor bars mirrors the cross section of the first and second conductor bars so that a geometric force coupling is generated in an overlapping between the joint conductor bars and the first and second conductor bars, between inclined planes having different inclinations therebetween.

59. The modular charging apparatus of claim 55, wherein the electrical connection means comprise a junction element comprising joint conductor bars and a closing plate made of insulating material that comprises an insulating prismatic portion projecting from the closing plate and comprising bar seats in which the joint conductor bars are engaged, prismatic portion having preferential extension in a direction orthogonal to the joint conductor bars.

60. The modular charging apparatus of claim 55, wherein at least one of the first bar module and the second bar module comprises isolators made of insulating material, which are suitable for keeping the first conductor bars and/or the second conductor bars, respectively, spaced apart and substantially parallel to one other for an extension thereof in the longitudinal extension direction.

61. The modular charging apparatus of claim 60, wherein the isolators each comprise a first rear isolator portion and a second front isolator portion, and wherein each of the first rear and second front isolator portions has respective grooves, each having a prevailing extension parallel to the longitudinal extension direction, the first rear isolator portion and the second front isolator portion being mutually engageable so that the respective grooves match to create a seat suitable for engaging the first conductor bars and/or the second conductor bars by shape coupling.

62. The modular charging apparatus of claim 55, wherein at least one of the first bar module and the second bar module comprises a casing that encloses the first conductor bars and/or the second conductor bars, the modular charging apparatus comprising one or more connection sockets suitable for allowing an electrical connection between the connection plug of one or more charging boxes and the first conductor bars and/or the second conductor bars, and wherein the casing is provided with socket seats in which the connection sockets are accommodated.

63. The modular charging apparatus of claim 55, wherein at least one of the first bar module and the second bar module comprises a casing enclosing the first conductor bars and/or the second conductor bars, wherein the casing comprises:
a back profile suitable for being fastened to one of a wall, a pedestal, or a support structure, and
a front profile suitable for facing a user,
the back profile and the front profile being engaged to each other, preferably geometrically coupled with snap coupling, to form the casing so as to contain the first conductor bars and/or the second conductor bars, optionally to create an airtight casing, and wherein the back profile is a metal section bar having a C-shaped cross section on a plane orthogonal to the longitudinal extension direction.

64. The modular charging apparatus of claim 55, wherein at least one of the first bar module and the second bar module comprises isolators made of insulating material and suitable for keeping the first conductor bars and/or the second conductor bars spaced apart and substantially parallel to one other for an extension thereof in the longitudinal extension direction, wherein at least one of the first bar module and the second bar module comprises a casing enclosing the first conductor bars and/or the second conductor bars, wherein the isolators comprise one or more load-bearing isolators at least partially fastened to the casing so as to support and keep suspended the first conductor bars and the second conductor bars and keep the first conductor bars and the second conductor bars integral with the casing, and wherein the load-bearing isolators comprise connection sockets.

65. The modular charging apparatus of claim 55, wherein at least one of the first bar module and the second bar module comprises isolators made of insulating material and suitable for keeping the first conductor bars and/or the second conductor bars spaced apart and substantially parallel to one other for an extension thereof in the longitudinal extension direction, wherein at least one of the first bar module and the second bar module comprises a casing enclosing the first conductor bars and/or the second conductor bars, and wherein the isolators comprise one or more auxiliary isolators exclusively engaged in the first conductor bars and/or the second conductor bars and independent of the casing.

66. The modular charging apparatus of claim 55, comprising one or more connection sockets suitable for allowing an electrical connection between the connection plug of one or more charging boxes and the first conductor bars and/or the second conductor bars, wherein the connection plug comprises conductor blades suitable for being inserted into the one or more connection sockets to come into contact with the first conductor bars or the second conductor bars and generate an elastic force pressing on the first conductor bars or the second conductor bars, and wherein the conductor blades have a cross section on a plane orthogonal to the longitudinal extension direction in a shape of a step, the conductor blades being suitable for being inserted into the one or more connection sockets to generate an elastic electrical contact force pressing on the first conductor bars or the second conductor bars and transmit current to the energy supply group.

67. A method for installing the modular charging apparatus of claim 54, the method comprising steps of:
a) providing:
a support structure, the support structure optionally being a pedestal or a wall,
a first bar module comprising first conductor bars;
a charging box comprising an energy supply group and a connection plug electrically connectable to the first conductor bars;
b) fastening the first bar module to the support structure so that the first bar module extends in a longitudinal extension direction; and
c) connecting the charging box to the first bar module via the connection plug at any point of an extension of the first bar module in the longitudinal extension direction, creating an electrical connection between the charging box and the first conductor bars.

68. The method of claim 67, further comprising steps of:
d) providing a second bar module comprising second conductor bars;
e) providing electrical connection means suitable for electrically connecting the first conductor bars and the second conductor bars, wherein the electrical connection means comprise: an isolator element in which bar seats are formed which at least partially receive the first conductor bars and are suitable for receiving at least partially the second conductor bars;
a junction element comprising joint conductor bars suitable for being inserted into the bar seats at least partially overlapping the first conductor bars and the second conductor bars and suitable for generating contact and force coupling therewith so as to ensure good electrical contact;
f) placing the second bar module adjacent to the first bar module in the longitudinal extension direction; and
g) electrically connecting the first conductor bars to the second conductor bars by the electrical connection means, wherein step g) comprises sub-steps of:
g1) at least partially inserting the second conductor bars into the bar seats; and
g2) inserting the joint conductor bars into the bar seats and generating force coupling with the first conductor bars and the second conductor bars.

69. A method for expanding a modular charging apparatus for charging one or more vehicles, optionally the one or more vehicles being electric, hybrid, or plug-in vehicles,
the method comprising:
a) providing
a modular charging apparatus comprising:
a first bar module comprising first conductor bars that are electrically powered and extend in a longitudinal extension direction;
a charging box comprising an energy supply group and a connection plug electrically connected to the first conductor bars and the energy supply group; and
a charging socket connected to the energy supply group and connectable to the one or more vehicles to allow a charge to be supplied from the energy supply group to the one or more vehicles,
wherein the first bar module is electrically connectable to a second bar module comprising second conductor bars, wherein the modular charging apparatus further comprises
a second bar module adjacent to the longitudinal extension direction, the second bar module comprising second conductor bars, and wherein the modular charging apparatus still further comprises
electrical connection means that electrically mutually connect the second conductor bars to the first conductor bars, allowing passage of electric current, and an additional bar module; and
b) connecting the first bar module or the second bar module to the additional bar module according to steps e), f) and g) of the method of claim 68.

70. A method for reducing a modular charging apparatus for charging one or more vehicles, optionally the one or more vehicles being electric, hybrid, or plug-in vehicles, the modular charging apparatus comprising:
a first bar module comprising first conductor bars that are electrically powered and extend in a longitudinal extension direction;
a charging box comprising an energy supply group and a connection plug electrically connected to the first conductor bars and the energy supply group; and
a charging socket connected to the energy supply group and connectable to the one or more vehicles to allow a charge to be supplied from the energy supply group to the one or more vehicles,
wherein the first bar module is electrically connectable to a second bar module comprising second conductor bars, wherein the modular charging apparatus further comprises
a second bar module adjacent to the longitudinal extension direction, the second bar module comprising second conductor bars, wherein the modular charging apparatus still further comprises
electrical connection means that electrically mutually connect the second conductor bars to the first conductor bars, allowing passage of electric current,
the method comprising:
a) removing the electrical connection means between the second bar module and the first bar module; and
b) removing the second bar module from the modular charging apparatus.

71. A method for managing distribution of current to the modular charging apparatus of claim 55, the method comprising steps of:
a) providing the modular charging apparatus of claim 55, comprising a plurality of charging boxes;
b) providing an electronic supply group and a power sensor that are operatively connected to the first conductor bars and to the second conductor bars and a central control unit;
c) on the power sensor, detecting power data required by the first bar module and/or by the second bar module;
d) on the electronic supply group, comparing the required power data with a predetermined maximum available power parameter;
e1) if the required power data is less than the predetermined maximum available power parameter, on the central control unit, dividing the required power among the charging boxes connected to a respective vehicle; or
e2) if the required power data is greater than the predetermined maximum available power parameter, setting as default the required power data with the maximum available power parameter and dividing the maximum available power among the charging boxes connected to a respective vehicle.

72. The method of claim 71, wherein step e1) includes equally distributing the required power among each of the charging boxes connected to the respective vehicle and wherein step e2) includes equally distributing the maximum power among each of the charging boxes.

73. A method for charging a vehicle by the modular charging apparatus of claim 54, the method comprising:
a) providing the modular charging apparatus of claim 54, the modular charging apparatus further comprising a central control unit;
b) connecting the charging socket to the vehicle to transmit a supply requirement to the energy supply group;
c) on the energy supply group, transmitting a work signal to the central control unit;
d) on the central control unit, checking that a power required by the vehicle is less than a power collectable from a grid;
e) from the central control unit, sending a supply command to the first conductor bars to supply the charging box with the power required by the vehicle; and
f) on the energy supply group, allowing supply of current to the vehicle by the charging socket.
